(19) United States
(12) Patent Application Publication
(10) Pub. No.: US 2026/0313404 A1
(43) Pub. Date: Oct. 8, 2026

(54) AUTOMATED ANTENNA ALIGNMENT SYSTEM FOR REAL-TIME MONITORING AND OPTIMIZATION

(71) Applicant: T-MOBILE INNOVATIONS LLC, Overland Park, KS (US)

(72) Inventors: Bhagwan Singh KHANKA, Las Vegas, NV (US); Paul Henrich Antonio GABRIEL, Las Vegas, NV (US)

(21) Appl. No.: 19/098,494

(22) Filed: Apr. 2, 2025

(51) Int. Cl. H04W 24/08; H01Q 1/12; H04B 7/08

(52) U.S. Cl. CPC H04W 24/08; H01Q 1/125; H04B 7/0834

(57) ABSTRACT

Embodiments of the present disclosure relate to an improved antenna system designed for real-time monitoring, reporting, and adjustment of an antenna panel's orientation. The system tracks horizontal tilt, vertical tilt, elevation, and rotation to detect deviations from optimal alignment. Real-time positional data is transmitted to a core network via a backhaul, allowing remote monitoring and control by network operators. Integrated stepper motors enable automatic or remote adjustments in response to misalignments. The system supports various sensor placements and power configurations. By automating alignment monitoring and correction, the system enhances network reliability, minimizes service disruptions, and reduces manual maintenance costs.

### SUMMARY

The present disclosure is directed to an improved antenna system and methods for monitoring, reporting, and adjusting the orientation of an antenna panel in real time.

According to various aspects herein, the system includes an Antenna Alignment Sensor Device which continuously tracks the positional orientation of an antenna panel, including horizontal tilt, vertical tilt, elevation, and rotation. The Antenna Alignment Sensor Device may include a gyroscope or other measurement-determining equipment capable of detecting misalignment due to environmental shifts, installation errors, or structural changes. A real-time reporting mechanism transmits alignment data to a network operator or an automated control system, facilitating remote diagnostics and proactive maintenance. In some embodiments, a set of stepper motors is integrated to automatically adjust the antenna panel's positional orientation based on the detected misalignment or remote operator commands.

The invention eliminates the need for manual realignment, enhancing network performance, reducing maintenance cost, and minimizing service disruptions. Additionally, the system may correlate alignment data with network key performance indicators (KPIs) to determine whether KPI degradation is caused by misalignment or external environmental factors, thereby improving overall network reliability and efficiency.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 depicts a computing device suitable for use with implementations of the present disclosure;

FIG. 2 illustrates a representative network environment for use with implementations of the present disclosure;

FIG. 3A illustrates an antenna panel, including representations of misalignment due to vertical tilt;

FIG. 3B illustrates an antenna panel, including representations of misalignment due to horizontal tilt;

FIG. 3C illustrates an antenna panel, including representations of misalignment due to rotation around its mounting structure;

FIG. 4 depicts a flow diagram of a method for monitoring and adjusting the positional orientation of an antenna panel in real time in accordance with aspects of the disclosure described herein; and

FIG. 5 depicts a flow diagram of a method for analyzing historical and current alignment data to generate one or more control signals for antenna adjustment in accordance with aspects of the disclosure described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, antenna systems used in wireless communication networks must be precisely aligned to ensure optimal signal transmission and coverage. Network engineers carefully design and position antenna panels to achieve specific coverage patterns, beam directions, and signal strengths, accounting for factors such as terrain, interference mitigation, and network capacity planning. However, various factors such as weather, seismic activity, structural shifts, installation errors, and routine maintenance operations can cause an antenna panel to become misaligned over time. Even minor deviations in horizontal tilt, vertical tilt, elevation, or rotation can lead to signal degradation, reduced network efficiency, increased interference, and service disruptions, ultimately affecting network performance and user experience. Because network operators typically lack direct, real-time monitoring of an antenna panel's alignment status, misalignments may go undetected until they cause network performance issues or are identified through visual inspection by field technicians or network engineers during routine maintenance or troubleshooting.

Conventionally, realigning an antenna panel requires manual inspection and adjustment by field technicians, which is time-consuming, labor-intensive, and costly. The process typically involves dispatching trained personnel to the antenna site, where they must physically access the antenna panel, often using climbing equipment, lifts, or specialized rigs to reach installations on towers, rooftops, or other elevated structures. Once positioned, technicians use mechanical adjustment mechanisms such as brackets, bolts, or mounting hardware. In some cases, handheld measurement tools, such as digital inclinometers, compasses, or GPS-based azimuth finders, are used to aid in achieve the desired orientation. However, this manual realignment process is prone to human error, and achieving precise alignment often requires multiple iterations of adjustment, followed by signal testing and optimization. This can lead to delays in restoring optimal antenna performance and increased operational costs.

Unlike conventional solutions, the present disclosure describes an improved antenna system and methods for monitoring and controlling the antenna system that enables real-time monitoring and automated adjustment of an antenna panel's alignment. The system includes an Antenna Alignment Sensor Device, which is configured to detect changes in horizontal tilt, vertical tilt, elevation, and rotation, providing continuous alignment data to a network operator or an automated control system. In some aspects, the system further includes one or more stepper motors configured to automatically adjust the antenna panel's position in response to detected misalignments, reducing the need for manual intervention. By integrating real-time monitoring, remote diagnostics, and automated correction mechanisms, the system enhances network performance, minimizes downtime, and significantly reduces operational costs associated with traditional realignment methods. Additionally, the system may incorporate network performance monitoring to correlate misalignments with signal degradation and key performance indicators (KPIs), enabling proactive adjustments and improved overall network reliability.

Accordingly, a first aspect of the present disclosure provides an improved antenna system. The system comprises an antenna panel with radiating elements comprising an Antenna Alignment Sensor Device, the Antenna Alignment Sensor Device configured to monitor positional orientation of the antenna panel, the positional orientation comprising at least one of horizontal tilt, vertical tilt, elevation and rotation. The system further comprises a real-time reporting system configured to transmit the positional orientation from the Antenna Alignment Sensor Device to a network operator.

A second aspect of the present disclosure provides method for monitoring and controlling an antenna panel. The method comprises measuring a positional orientation of the antenna panel. The method further comprises transmitting the positional orientation to a network operator. The method further comprises adjusting the positional orientation of the antenna panel.

Another aspect of the present disclosure provides method for monitoring and controlling an antenna panel. The method comprises receiving current positional orientation of an antenna panel from an integrated monitoring device. The method further comprises analyzing current positional orientation and historical positional orientations to determine if there is a deviation in a current positional orientation of the antenna panel from a previous positional orientation of the antenna panel. The method further comprises generating one or more control signals to adjust the current positional orientation of the antenna panel. The method further comprises transmitting the one or more control signals to the antenna system to adjust the current positional orientation of the antenna panel.

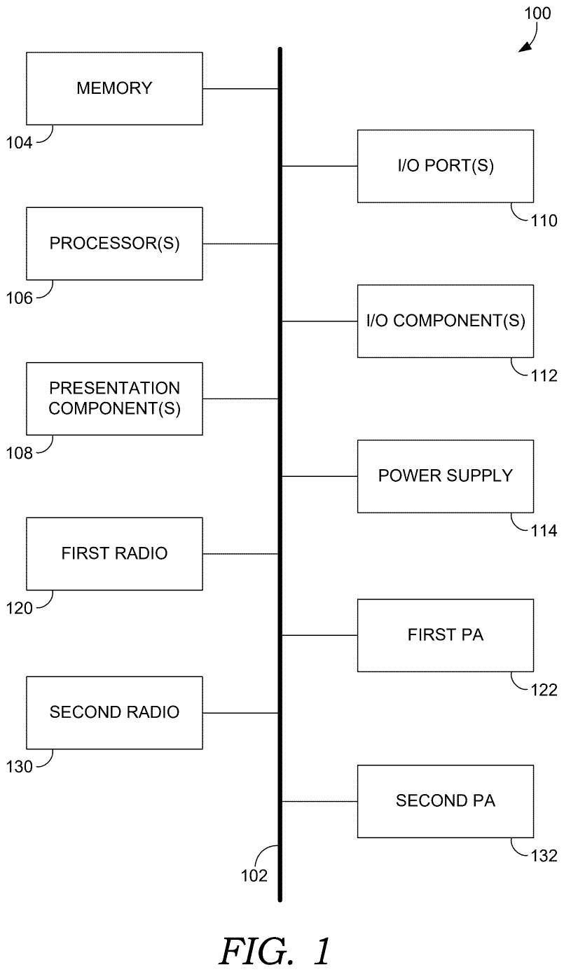

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device. The computing device 100 may take the form of a wireless access device that acts as a more localized and consolidated access point that provides end user wireless devices access to a broader network; examples of wireless access devices include fixed wireless access (FWA) devices and mobile hotspots. The computing device 100 may take the form of a mobile device, used herein to refer to categories of often-portable devices that utilize a wireless connection to a broader network and are typically configured for direct human interaction and personal computing tasks; examples of mobile devices include smartphones, tablets, extended reality (XR) device (e.g., augmented reality (AR), virtual reality (VR), and mixed reality (MR)), computers (e.g., laptops and PCs), wearable devices (e.g., smartwatches, fitness tracker), electronic readers (i.e., an e-book reader or digital book reader), portable media player, handheld GPS/location device, digital camera, gaming console, and digital voice recorders. The computing device may take the form of a connected vehicle that integrates advanced communication and computing technologies to interact with other devices and networks, encompassing vehicle to vehicle (V2V) communications, vehicle to infrastructure (V2I) communications, and/or vehicle to everything (V2X) communications, and that utilizes a wireless connection to support telematics, infotainment systems, over the air updates, vehicle health monitoring, and/or enhanced navigation; examples of connected vehicles include automotive, locomotive, airborne, and cargo (e.g., train car, semi-trailer) systems. The computing device 100 may take the form of an Internet of Things (IoT) device, a physical object embedded with sensors, software, or other technologies that enable them to collect, exchange, and act on data using an internet connection, which allows them to perform automated, decision-making or, other content-provision tasks; examples of IoT devices include smart home devices (e.g., smart thermostats, smart lights, power supply/management systems, and smart security systems), connected appliances (e.g., smart refrigerators), health monitoring devices (e.g., blood pressure monitor, glucose monitor), industrial devices (e.g., smart sensors, predictive maintenance systems), and agricultural devices (e.g., soil, environmental, or growth sensors).

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and a second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, 802.11, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VoLTE, or other VoIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may configured to communicate with one or more other computing devices according to a local area communication protocol (e.g., IEEE 802.11 series, Bluetooth, NFC, z-wave, or the like).

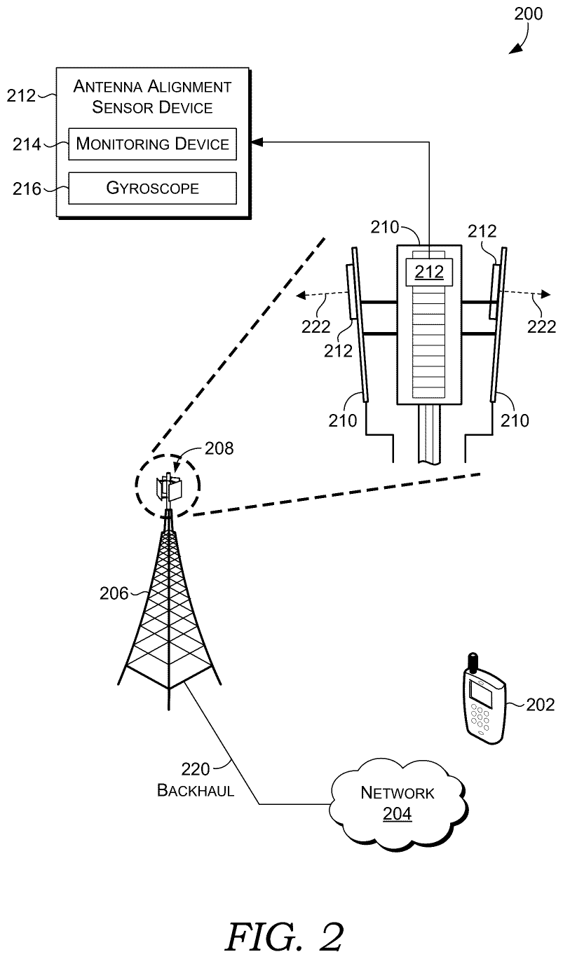

Turning now to FIG. 2, a representative network environment 200 is illustrated, in which implementations of the present disclosure may be employed. At a high level, the network environment 200 comprises a user equipment (UE) 202, one or more base stations, such as base station 206, a core network 204, and a backhaul 220 configured to communicate with the core network 204 using one or more of cellular, microwave, satellite, fiber-optic or Wi-Fi communication technologies. The RAN node at the base station 206 may be configured to provide wireless communication coverage over at least a portion of a predefined coverage area. To facilitate this coverage, the RAN node may be operatively coupled to an antenna array 208, which is designed to support wireless communication within the predefined coverage area by transmitting and receiving signals across designated frequency bands. The antenna array 208 may include one or more antenna panels 210, each comprising a set of radiating elements optimized for signal propagation, beamforming, and interference mitigation. In some aspects, the antenna array 208 may be configured as a massive MIMO (Multiple Input, Multiple Output) system, beamforming array, or another advanced configuration to enhance signal directivity, spectral efficiency, and overall network performance. Each antenna panel 210 within the antenna array 208 may be individually or collectively controlled, as described herein, to dynamically adjust coverage patterns, beam angles, and polarization based on real-time network demands, environmental conditions or operator commands. In some embodiments, the system may incorporate automated alignment mechanisms, such as one or more stepper motors and an Antenna Alignment Sensor Device, to ensure optimal positioning and performance of the antenna panel over time.

Although FIG. 2 illustrates the antenna array 208 and antenna panel 210 as mounted to a base station 206, the antenna array 208 and antenna panel 210 may be mounted on a tower, rooftop, or other elevated structures to achieve optimal coverage, signal propagation, and network performance. In yet other aspects, the antenna panel 210 may take the form of any antenna system that benefits from directional calibration, which may be used in many different use cases or technical environments; for example, a Yagi-Uda antenna used in an amateur radio system, a directional phased array or parabolic antenna used by consumers to receive satellite signals, a helical antenna for GPS applications, a horn antenna for high-frequency microwave communications, a patch/sector/panel antenna in a Wi-Fi router, or a patch antenna array for beamforming in millimeter-wave 5G networks. One skilled in the art will recognize yet other use cases of the antenna panel 210. The positioning of the antenna panel 210 may be determined based on factors such as network design requirements, terrain considerations, building density, and interference mitigation strategies to ensure reliable connectivity and minimize signal degradation. The antenna array 208 and antenna panel 210 may be deployed across various network environments, including macro cell sites for wide-area coverage, small cell installations for capacity enhancements in urban or high-density locations, and other infrastructure configurations, such as enterprise networks, stadiums, remote communication hubs, and residential fixed wireless access (FWA) systems. Although the system and method disclosed herein are illustrated in the context of a wireless communication network, it is expressly conceived to be used with any wireless communications system that utilizes antenna where alignment is important or communication deployments where directionality is important. In some implementations, the antenna panel 210 may be part of a home-based device provided by a wireless network carrier to deliver broadband internet to residential users. Such devices, often referred to as customer-premises equipment (CPE), may rely on precise antenna alignment to maintain a stable connection with the network and optimize performance in response to changing environmental conditions. In these cases, the automated alignment technology described herein may enhance signal reliability, reduce service interruptions, and improve overall network efficiency for home users.

The antenna panel 210 may include an Antenna Alignment Sensor Device 212, which is configured to monitor positional orientation of the antenna panel 210 in real time. As used herein, positional orientation may refer to the spatial alignment of the antenna panel 210 relative to a reference position and may include one or more of horizontal tilt, vertical tilt, elevation, and rotation. In some embodiments, positional orientation may also encompass azimuth, which defines the antenna panel's 210 directional alignment relative to a fixed reference point, such as true north or a network-specified coordinate. Additionally, positional orientation may account for changes in height above sea level, which may be relevant for altitude-based signal optimization. The system described herein is configured to monitor, detect deviations in, and adjust the positional orientation of the antenna panel 210 to ensure optimal network performance.

In aspects, as shown in FIG. 2, the Antenna Alignment Sensor Device 212 is mounted to the antenna panel. The positioning of the Antenna Alignment Sensor Device 212 may be determined based on factors such as network design requirements, terrain considerations, building density, and interference mitigation strategies to ensure reliable connectivity and minimize signal degradation. For example, as depicted in FIG. 2, the Antenna Alignment Sensor Device 212 may be located on a front face of a front panel of the antenna panel 210. The Antenna Alignment Sensor Device 212 may be located on an inner face of a back panel of the antenna panel 210. The Antenna Alignment Sensor Device 212 may be located on a mounting bracket or support structure connected to the antenna panel 210. In aspects, the Antenna Alignment Sensor Device 212 may be mounted to the antenna panel along a boresight 222 of the antenna panel 210. The boresight 222 of the antenna panel 210 is the axis along which the antenna panel 210 radiates or receives the maximum signal strength. The boresight 222 is the central axis of the main lobe of the antenna panel's 210 radiation pattern. Ensuring the antenna panel 210 is accurately aimed along its boresight is crucial for achieving maximum performance and signal coverage. In aspects, the boresight may be perpendicular to the antenna panel 210.

The Antenna Alignment Sensor Device 212 may comprise at least a monitoring device 214 and a communication component 216. The monitoring device 214 may comprise any one or more sensors that may be used to detect alignment, orientation, movement, or the like, which may be used to determine that the antenna panel 210 is mis-aligned. The monitoring device 214 may, for example, comprise one or more of a gyroscope, accelerometer for detecting linear movement or sudden shifts that may indicate external forces acting on the antenna panel; magnetometer for determining orientation relative to the Earth's magnetic field, assisting in azimuth calibration; inclinometer, for measuring precise angular tilt to ensure proper elevation adjustments; and altimeter, for determining the height of the antenna panel above sea level, which may be relevant for altitude-based signal optimization. These and other sensors may be used individually or in combination to provide a comprehensive alignment tracking system, enabling real-time adjustments based on environmental changes, structural movement, or network optimization requirements. The integration of multiple sensors allows for greater accuracy in positioning and facilitates automated or remote realignment of the antenna panel.

The monitoring device 214 of the Antenna Alignment Sensor Device 212 may, in some implementations, be an Internet of Things (IoT) device configured to collect, process, and transmit real-time alignment and performance data. The monitoring device 214 may be responsible for continuously tracking the positional orientation of the antenna panel 210, including horizontal tilt, vertical tilt, elevation, and rotation, using an integrated communication component 216. These measurement determining components may provide real-time data on tilt, azimuth, and height above sea level, ensuring that the antenna remains properly aligned for optimal signal transmission and network performance. In addition to tracking positional orientation, the monitoring device 214 may detect external environmental changes impacting the antenna's effectiveness. This may include, but is not limited to, identifying new buildings, growing trees, or crowd density changes that could obstruct signals. By continuously monitoring deviations from the antenna panel's 210 original alignment through the monitoring device 214, the system can detect shifts in height, tilt, and azimuth settings that may indicate movement due to high winds or structural shifts.

To improve network diagnostics and troubleshooting, the monitoring device 214 may cross-references alignment data with network key performance indicators, or KPIs, which may include metrics such as signal strength, data throughput, and customer experience indicators. If a degradation in one or more KPIs occurs without a corresponding deviation in the positional orientation of the antenna panel 210 from a previous positional orientation of the antenna panel 210, the system may determine that the degradation in the one or more KPIs is due to an external environmental factor rather than misalignment of the antenna panel 210. The system may further identifying one or more potential environmental causes of the degradation. Conversely, if a degradation in one or more KPIs occurs with a corresponding deviation in the positional orientation of the antenna panel 210 from a previous positional orientation of the antenna panel 210, they system may determine that the degradation in one or more KPIs is caused by movement of the antenna panel 210.

The monitoring device 214 is additionally configured to communicate one or more indications of mis-alignment of the antenna panel 210 to the communication component 216. The communication component 216 is generally configured to transmit real-time alignment and performance data to a remote destination, such as to a network operation center or to Optimization and Performance Engineers via a Graphical User Interface (GUI), enabling remote monitoring and control of the antenna panel 210. The transmission of real-time data may occur over a backhaul network, which serves as the communication link between the antenna panel and the core network. The backhaul may utilize one or more of the following communication technologies: cellular, microwave, satellite, fiber-optic, or Wi-Fi to relay alignment data, sensor readings, and network performance metrics to the core network for processing and analysis. Once received by the core network, the data may be accessed by network operators and performance engineers, who may analyze real-time positional orientation changes, network KPIs, and external environmental factors to determine whether adjustments to the antenna panel 210 are required. The GUI interface allows engineers to visualize sensor readings, detect deviations, and remotely send one or more control signals to adjust the antenna panel's 210 horizontal tilt, vertical tilt, azimuth, or elevation. Additionally, the system may generate detailed reports, including site-specific alignment data, timestamps, market conditions, and recorded adjustments, enabling proactive network optimization, fault prevention, and automated corrective actions.

Based on the positional orientation data received by the network operator, the system may determine whether adjustments to the antenna panel 210 are necessary to maintain optimal alignment and network performance. If a deviation in horizontal tilt, vertical tilt, azimuth, or elevation is detected, remediation procedures may be initiated to correct the misalignment. In aspects, performing remediation procedures may include manual adjustment by engineers. Field engineers may manually inspect and adjust the antenna panel 210 to restore proper alignment. This may involve physically accessing the antenna panel 210 using lifts, climbing equipment, or scaffolding to reach installations on towers, rooftops, or other elevated structures. Engineers may use handheld measurement tools, such as digital inclinometers, compasses, or GPS-based azimuth finders, to determine the necessary adjustments. Once positioned, the engineer may manually loosen mounting hardware, adjust the antenna panel's 210 angle, and secure it back into place, ensuring proper horizontal tilt, vertical tilt, azimuth, and elevation. After adjustments are made, the engineer may verify the new orientation using real-time data from the Antenna Alignment Sensor Device 212 to confirm that the panel is correctly positioned.

In aspects, one or more stepper motors may be integrated with the antenna panel 210 and may adjust the antenna panel's 210 positional orientation without requiring direct manual intervention. In example aspects, the system may be configured to perform fully automated realignment without requiring human intervention. The monitoring device 214 may continuously monitor the antenna panel's 210 positional orientation, and if a deviation exceeds a predefined threshold, the system may autonomously generate a realignment command. The one or more stepper motors may then execute precise adjustments in small, controlled increments to return the antenna panel 210 to its optimal orientation. This process ensures real-time corrections, minimizing performance degradation without requiring network engineers to intervene. After the adjustment is completed, the Antenna Alignment Sensor Device 212 may verify the new alignment by re-evaluating real-time data to confirm that the correction aligns with the intended positioning. If further refinement is required, the system may initiate additional automated corrections based on feedback data.

In aspects, network operators or optimization engineers may detect misalignment via the GUI and may manually send realignment commands remotely. When the GUI displays real-time positional orientation data indicating misalignment, engineers may analyze the deviation and input precise adjustment parameters. These commands may be transmitted over the backhaul network to the antenna panel 210, where the one or more stepper motors may execute the instructed adjustments. Remote realignment may allow engineers to fine-tune an antenna panel's 210 position without dispatching field technicians, significantly reducing operational costs and downtime. Once the remote adjustments are performed, the system may generate a verification report via the GUI, allowing engineers to confirm the realignment using real-time data from the Antenna Alignment Sensor Device 212. If necessary, additional refinements may be applied until the antenna panel 210 is restored to its optimal position. Regardless of the remediation procedure used, the system may ensure precise, efficient, and reliable antenna panel 210 realignment, enhancing network stability, reducing signal degradation, and improving overall service quality.

The one or more stepper motors which may be integrated with the antenna panel 210 may be responsible for executing precise positional adjustments to maintain optimal alignment based on real-time sensor data or remote operator commands. These motors may operate in fixed angular increments (steps), allowing for fine-tuned control over movement. Depending on system requirements, they may function in full-step mode, where each step corresponds to a discrete angular movement, half-step mode for improved resolution, or microstepping mode, which enables smoother motion and enhanced precision by dividing each step into smaller increments. The motors may be designed to provide sufficient holding torque to counteract external forces such as wind loads, structural vibrations, or environmental disturbances, ensuring the antenna panel 210 remains securely positioned. The stepper motors may be controlled using either an open-loop or closed-loop system. In an open-loop configuration, the motor moves according to predefined step commands without real-time feedback. In contrast, a closed-loop control system continuously receives positional orientation data from the Antenna Alignment Sensor Device 212, allowing for real-time corrections if a deviation from the desired position is detected. In such implementations, the sensor device may verify each movement and provides feedback to the motor controller, ensuring that the antenna panel 210 is properly realigned. If the antenna panel 210 remains misaligned after an adjustment, the system may issue additional corrective steps until the optimal position is restored.

Stepper motor adjustments may occur in two primary ways: automated realignment or remote-controlled realignment. In automated realignment, the Antenna Alignment Sensor Device 212 may continuously monitor horizontal tilt, vertical tilt, rotation, azimuth, and elevation, and if a deviation exceeds a predefined threshold, the system may autonomously activate the stepper motors to correct the misalignment without human intervention. This may ensure that any misalignment is addressed immediately, minimizing potential performance degradation. In remote-controlled realignment, network operators or performance engineers may detect a deviation via the GUI and issue realignment commands. These commands may be transmitted over the backhaul network to the antenna panel 210. The stepper motors may then execute the specified adjustments, and once the realignment is completed, the Antenna Alignment Sensor Device 212 may verify the new position and may send confirmation data back to the operator.

Power for the stepper motors may be supplied directly from a primary power source of the antenna panel 210, a dedicated battery backup system, or via Power-over-Ethernet (PoE), depending on deployment conditions. To enhance energy efficiency, the system may include a low-power standby mode, in which the motors remain inactive until a realignment command is issued, thereby reducing unnecessary power consumption. As the stepper motors may be deployed in outdoor environments, they may be equipped with weather-resistant enclosures to protect against dust, moisture, and extreme temperatures. To further enhance stability, vibration-damping mounts may be incorporated to prevent unintended movement caused by structural oscillations. Additionally, fail-safe mechanisms, such as manual override options, may be implemented to ensure operability in case of motor failure or communication loss.

The Antenna Alignment Sensor Device 212 may be electrically powered by various energy sources, depending on the specific deployment requirements, infrastructure availability, and operational constraints. In some implementations, the Antenna Alignment Sensor Device 212 may receive power through a direct connection to a primary power source of the antenna panel 210, ensuring continuous operation by drawing power from the existing electrical infrastructure of the antenna system. In other implementations, the Antenna Alignment Sensor Device 212 may be powered by a battery housed within the sensor device, allowing for self-sustained operation even in environments where direct power connections are unavailable or impractical. The battery may be rechargeable or replaceable, depending on system design requirements, and may be optimized for low-power consumption to extend operational lifespan. Alternatively, the Antenna Alignment Sensor Device 212 may be powered through a Power-over-Ethernet (PoE) connection, which delivers both electrical power and data connectivity over a single network cable. This configuration simplifies installation by eliminating the need for a separate power source, reducing cabling complexity, and ensuring uninterrupted operation as long as network connectivity is maintained. In some aspects, the Antenna Alignment Sensor Device 212 may incorporate an energy harvesting mechanism, allowing it to generate power from available environmental sources. Such mechanisms may include solar panels, which convert sunlight into electrical energy; RF energy harvesting, which captures and converts radio frequency signals into usable power; or vibration-based energy harvesting, which utilizes mechanical motion from wind or structural vibrations to generate electricity. These energy harvesting methods may be particularly beneficial for remote or off-grid installations, where conventional power sources are unavailable.

The UE 202 of the network environment 200 may be configured to wirelessly communicate with the one or more base stations 206 of the network environment 200. The UE 202 may take on a variety of forms, such as a personal computer (PC), a user device, a smart phone, a smart watch, an extended reality (XR) device, Internet of Things (IoT) device, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device that comprising any one or more feature of computing device 100 of FIG. 1.

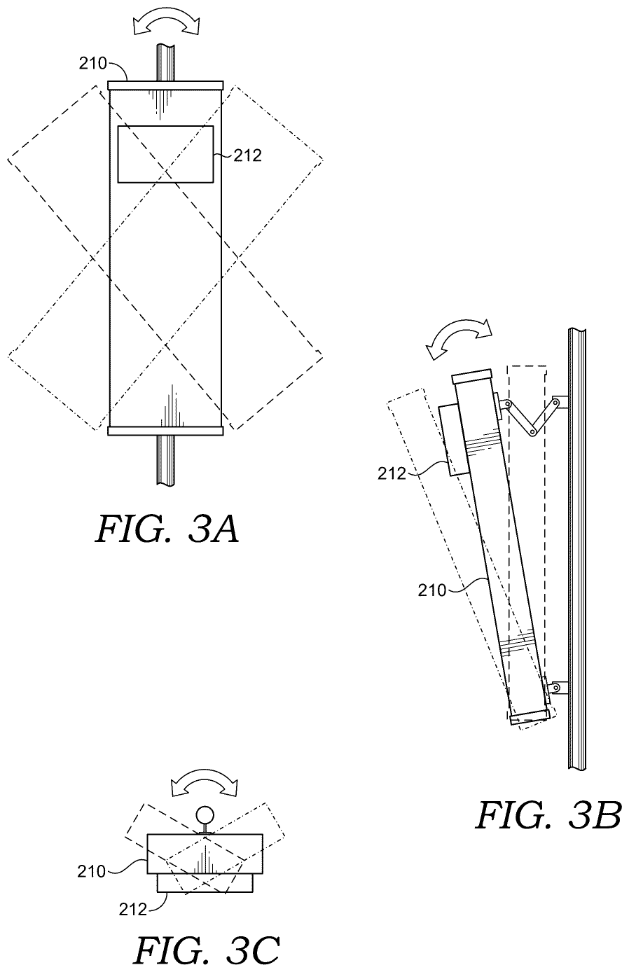

Turning now to FIGS. 3A, 3B, and 3C, various positional orientations of an antenna panel 210 are illustrated to demonstrate how the Antenna Alignment Sensor Device 212 may detect and monitor deviations from an optimal alignment. FIG. 3A provides a front view of a single antenna panel 210 in its default, vertically aligned position. Overlaid on this view are two dashed outlines, each representing a tilted orientation of the antenna panel. One dashed outline illustrates the panel tilted to the left, while the other, distinguished by a different dash pattern, represents the panel tilted to the right. These misalignments may occur due to external forces such as weather, structural shifts, or improper installation. The Antenna Alignment Sensor Device 212 continuously monitors these changes in vertical tilt and provides real-time data to determine whether adjustments as described herein are necessary.

FIG. 3B illustrates a side view of the antenna panel 210, depicting misalignment due to changes in vertical tilt forward or backward. Similar to FIG. 3A, the default orientation is shown as a solid outline, while two additional dashed outlines represent deviations in the forward and backward directions. This type of misalignment can occur due to loosening of mounting hardware, mechanical fatigue, or environmental disturbances. The Antenna Alignment Sensor Device 212 detects these deviations and may trigger remediation procedures as described herein.

FIG. 3C provides a top-down view of the antenna panel 210, illustrating how the antenna may become misaligned due to unintended rotation around its mounting structure. The solid outline represents the default azimuth alignment, while two dashed outlines indicate rotational deviations in opposite directions. Such rotational misalignment may result from wind-induced torque, improper bracket fastening, or gradual environmental shifts over time. As described herein, the Antenna Alignment Sensor Device 212 may detect these rotational deviations and may generate one or more control signals for automatic realignment using stepper motors or issue alerts to network operators for manual or remote adjustments.

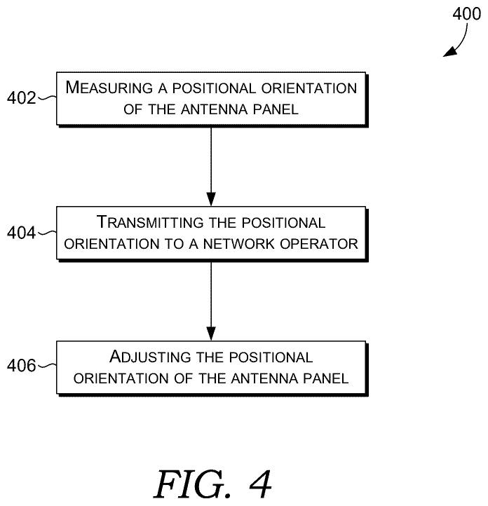

FIG. 4 depicts a flow chart representing a method for monitoring and controlling an antenna panel 400. The method 400 begins with step 402, measuring a positional orientation of the antenna panel. The method continues with step 404, transmitting the positional orientation to a network operator. The method continues with step 406, adjusting the positional orientation of the antenna panel.

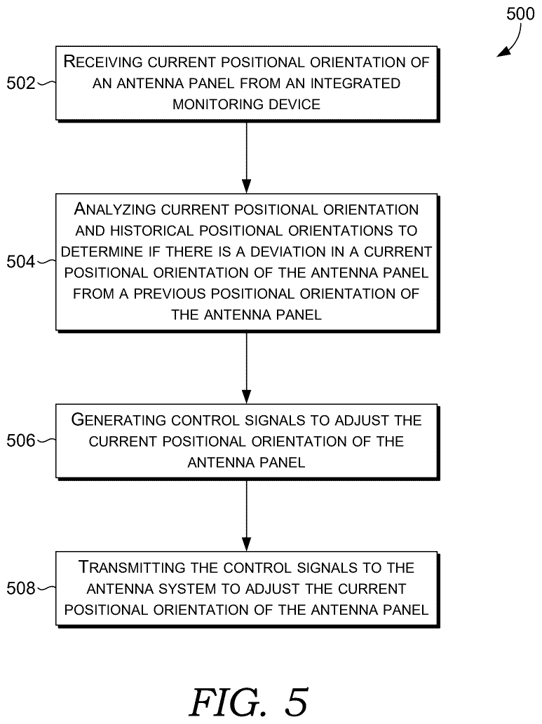

FIG. 5 depicts a flow chart representing a method for monitoring and controlling an antenna panel 500. The method 500 begins with step 502, receiving current positional orientation of an antenna panel from an integrated monitoring device. The method continues with step 504, analyzing current positional orientation and historical positional orientations to determine if there is a deviation in a current positional orientation of the antenna panel from a previous positional orientation of the antenna panel. The method continues with step 506, generating one or more control signals to adjust the current positional orientation of the antenna panel. The method continues with step 508, transmitting the one or more control signals to the antenna system to adjust the current positional orientation of the antenna panel.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. An improved antenna system comprising:
an antenna panel with radiating elements comprising an Antenna Alignment Sensor Device, the Antenna Alignment Sensor Device configured to monitor positional orientation of the antenna panel, the positional orientation comprising at least one of horizontal tilt, vertical tilt, elevation and rotation; and
a real-time reporting system configured to transmit the positional orientation from the Antenna Alignment Sensor Device to a network operator.

2. The improved antenna system of claim 1, wherein the Antenna Alignment Sensor Device comprises a monitoring device and a gyroscope.

3. The improved antenna system of claim 2, wherein the improved antenna system further comprises a set of one or more stepper motors configured to adjust the positional orientation of the antenna panel.

4. The improved antenna system of claim 3, wherein, based on the positional orientation received by the network operator, the network operator sends one or more control signals to the antenna panel and the one or more stepper motors adjust the positional orientation of the antenna panel.

5. The improved antenna system of claim 1, further comprising a backhaul configured to communicate with a core network using one or more of cellular, microwave, satellite, fiber-optic or Wi-Fi communication technologies.

6. The improved antenna system of claim 1, wherein the Antenna Alignment Sensor Device is positioned at least one of:
on an inner face of a back panel of the antenna panel;
on a front face of a front panel of the antenna panel; and
on a mounting bracket or support structure connected to the antenna panel.

7. The improved antenna system of claim 6, wherein the Antenna Alignment Sensor Device mounted to the antenna panel along a boresight of the antenna panel.

8. The improved antenna system of claim 7, wherein the Antenna Alignment Sensor Device is electrically powered by at least one of:
a direct connection to a power supply of the antenna panel;
a battery housed within the Antenna Alignment Sensor Device;
a power-over-Ethernet (PoE) connection through a network cable; and
an energy harvesting mechanism.

9. A method for monitoring and controlling an antenna panel, the method comprising:
measuring a positional orientation of the antenna panel;
transmitting the positional orientation to a network operator; and
adjusting the positional orientation of the antenna panel.

10. The method for monitoring and controlling an antenna panel of claim 9, wherein the positional orientation is determined by a gyroscope measuring horizontal tilt, vertical tilt, elevation and rotation of the antenna panel.

11. The method for monitoring and controlling an antenna panel of claim 9, wherein the adjusting of the positional orientation of the antenna panel is automatically performed by one or more stepper motors.

12. The method for monitoring and controlling an antenna panel of claim 9, the method further comprising receiving one or more control signals from the network operator based on the positional orientation.

13. The method for monitoring and controlling an antenna panel of claim 9, the method further comprising determining a deviation in the positional orientation of the antenna panel from a previous positional orientation of the antenna panel.

14. The method for monitoring and controlling an antenna panel of claim 13, further comprising monitoring one or more network key performance indicators (KPIs) associated with the antenna panel and determining whether the deviation in the positional orientation of the antenna panel from the previous positional orientation of the antenna panel is correlated with a degradation in the one or more network KPIs.

15. The method for monitoring and controlling an antenna panel of claim 14, wherein if the degradation in the one or more network KPIs occurs without the deviation in the positional orientation of the antenna panel, determining that the degradation is caused by an external environmental factor.

16. The method for monitoring and controlling an antenna panel of claim 15, further comprising identifying one or more potential environmental causes of the degradation.

17. The method for monitoring and controlling an antenna panel of claim 14, wherein if the degradation in the one or more network KPIs occurs with a corresponding deviation in the positional orientation of the antenna panel from the previous positional orientation of the antenna panel, determining that the degradation is caused by movement of the antenna panel.

18. The method for monitoring and controlling an antenna panel of claim 9, further comprising utilizing a backhaul configured to communicate with a core network, wherein the backhaul uses one or more of cellular, microwave, satellite, fiber-optic or Wi-Fi communication technologies to communicate with the core network.

19. A method for monitoring and controlling an antenna system, the method comprising:
receiving current positional orientation of an antenna panel from an integrated monitoring device;
analyzing current positional orientation and historical positional orientations to determine if there is a deviation in a current positional orientation of the antenna panel from a previous positional orientation of the antenna panel;
generating one or more control signals to adjust the current positional orientation of the antenna panel; and
transmitting the one or more control signals to the antenna system to adjust the current positional orientation of the antenna panel.

20. The method for monitoring and controlling an antenna system of claim 19, the method further comprising cross-referencing the deviation with network performance metrics to identify potential causes of performance degradation.
